(19) United States
(12) Patent Application Publication
(10) Pub. No.: US 2012/0020760 A1
(43) Pub. Date: Jan. 26, 2012

(54) TRANSPORTATION CARRIER FOR GLASS SUBSTRATE

(75) Inventor: Hsin-Wei HUANG, Yilan County (TW)

(73) Assignee: Du Pont Apollo Limited, Hong Kong (HK)

(21) Appl. No.: 13/184,571

(22) Filed: Jul. 18, 2011

(30) Foreign Application Priority Data
Jul. 23, 2010 (CN) 201010237867.0

(51) Int. Cl. B65G 49/06

(52) U.S. Cl. 414/225.01; 414/222.01

(57) ABSTRACT

A glass substrate transportation carrier is provided, which includes a base; a glass holding stage for adsorbing a glass substrate; an elevating mechanism disposed between the base and the glass holding stage; an overturning mechanism disposed between the elevating mechanism and the glass holding stage; a rotating mechanism disposed between the overturning mechanism and the elevating mechanism; and a telescopic mechanism disposed between the overturning mechanism and the glass holding stage.

### RELATED APPLICATIONS

This application claims priority to China Application Serial Number 201010237867.0, filed Jul. 23, 2010, which is herein incorporated by reference.

### BACKGROUND

1. Field of Invention

The present invention relates to a transportation carrier. More particularly, the present invention relates to a transportation carrier for glass substrate.

2. Description of Related Art

Solar energy is a form of energy source. Due to daily depleted earth's resources and the pollution and safety problems caused by conventional fossil fuel or nuclear energy, the solar energy becomes a potential alternative energy resource, and many developed countries and large-scale enterprises are successively devoted to this field for developing alternative energy resources.

A solar cell mainly includes glass substrates and a photoelectric conversion material sandwiched between the glass substrates. Besides glass, a glass substrate further includes a plurality of film layers coated on the glass, and the thickness of the film layers must conform to a certain specification, and thus an NSPR machine is required to perform a series of inspections in the plant.

When the NSPR machine is used to perform an inspection in a production line, the glass substrates are manually transported and moved between the NSPR machine and other machines. Since the inspection of the glass substrates is performed with a fixed direction, currently, the glass substrates generally relied on manual transportation to change their directions.

The manual transportation not only has a low efficiency but also easily causes breakage of substrates during transportation. Therefore, an important topic is how to reduce the breakage of the glass substrates of the solar cell during transportation and improve the inspection efficiency of the glass substrates.

### SUMMARY

Therefore, the present invention aims to provide a glass substrate transportation carrier for transporting glass substrates, so as to reduce the breakage of the glass substrates during transportation and improve the inspection efficiency of the glass substrates.

According to an embodiment of the present invention, a glass substrate transportation carrier is provided, and includes a base; a glass holding stage for adsorbing a glass substrate; an elevating mechanism disposed between the base and the glass holding stage; an overturning mechanism disposed between the elevating mechanism and the glass holding stage; a rotating mechanism disposed between the overturning mechanism and the elevating mechanism; and a telescopic mechanism disposed between the overturning mechanism and the glass holding stage.

The glass substrate transportation carrier may further include a moving mechanism disposed on the base. The glass holding stage further includes a plurality of suction cups and a plurality of air suction ports. The elevating mechanism may be an air pressure cylinder, an oil pressure cylinder or a screw rod. The telescopic mechanism includes a rail and a sliding member, wherein the rail extends from the overturning mechanism, and the sliding member is disposed on the rail and slides relative to the rail, and the sliding member and the glass holding stage are connected. The glass substrate transportation carrier further includes a solar cell disposed on the base. The glass substrate transportation carrier further includes a control panel for controlling the glass substrate transportation carrier.

The present invention provides a glass substrate transportation carrier, which can reduce the breakage of glass substrates during transportation and improve the inspection efficiency of the glass substrates.

### BRIEF DESCRIPTION OF THE DRAWINGS

The above and other objectives, features, advantages and embodiments of the present invention can be more fully understood with reference to the accompanying drawings as follows:

FIG. 1 is a schematic view of a glass substrate transportation carrier according to an embodiment of the present invention;

FIG. 2 is a top view of the glass substrate transportation carrier in an operation state according to the present invention;

FIG. 3 is a side view of the glass substrate transportation carrier in another operation state according to the present invention; and

FIG. 4 is a schematic view of a glass substrate transportation carrier according to a second embodiment of the present invention.

### DETAILED DESCRIPTION

The following describes the spirit of the present invention with reference to the drawings and embodiments. After understanding the embodiments of the present invention, one of ordinary skill in the art may make alterations and modifications by using the techniques described in the present invention, and such alterations and modifications shall fall within the spirit and scope of the present invention.

FIG. 1 is a schematic view of a glass substrate transportation carrier according to an embodiment of the present invention. The glass substrate transportation carrier 100 includes a base 110, a glass holding stage 120, an elevating mechanism 130 disposed between the base 110 and the glass holding stage 120, a moving mechanism 140 disposed on the base 110, an overturning mechanism 150 disposed between the glass holding stage 120 and the elevating mechanism 130, a rotating mechanism 160 disposed between the overturning mechanism 150 and the elevating mechanism 130, and a telescopic mechanism 170 connecting the overturning mechanism 150 and the glass holding stage 120.

The glass holding stage 120 is used for adsorbing a glass substrate. The moving mechanism 140 may be rolling wheels disposed under the base 110, so that the glass substrate transportation carrier 100 may freely move in the plant. The elevating mechanism 130 may be an air pressure cylinder, an oil pressure cylinder or a screw rod, etc., and the height of the glass holding stage 120 can be changed by using the elevating mechanism 130. The overturning mechanism 150 is used for overturning the glass holding stage 120 and the glass substrate adsorbed on the glass holding stage 120, and thereby the glass substrate is turned over from one side facing upwards to the other side facing upwards. The rotating mechanism 160 is used to rotate the overturning mechanism 150 and the glass holding stage 120 connected to the overturning mechanism 150, thereby rotating the glass substrate on the glass holding stage 120 to a desired angle. The telescopic mechanism 170 shifts the glass holding stage 120, and thereby the glass holding stage 120 moves back and forth on the same plane to facilitate adsorbing or removing the glass substrate.

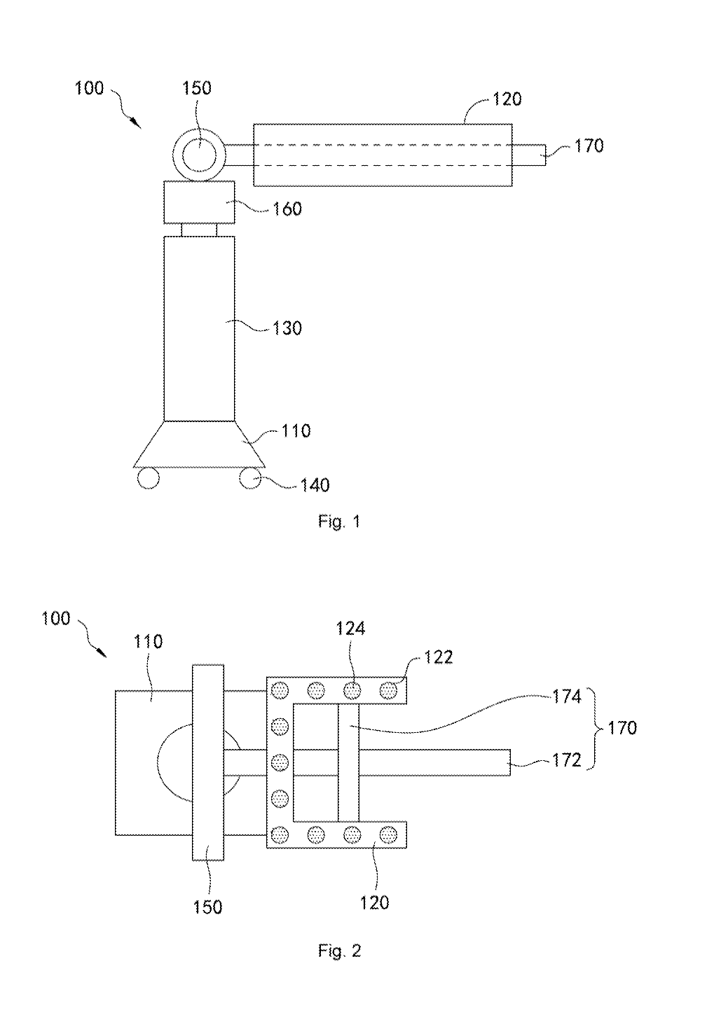

FIG. 2 is a top view of the glass substrate transportation carrier in an operation state according to the present invention. A plurality of suction cups 122 and a plurality of air suction ports 124 are disposed on the glass holding stage 120. When the glass holding stage 120 moves to contact the glass substrate, the suction cups 122 on the glass holding stage 120 can adsorb the glass substrate, and tightly adsorb the glass substrate via a near-vacuum condition formed by actuating the air suction ports 124, thereby preventing the glass substrate from dropping down during transportation. The telescopic mechanism 170 includes a rail 172 and a sliding member 174. The rail 172 extends from the overturning mechanism 150, and the sliding member 174 is disposed on the rail 172 and slides relative to the rail 172, and the sliding member 174 and the glass holding stage 120 are connected, so that the glass holding stage 120 can slide back and forth relative to the rail 172 through the sliding member 174.

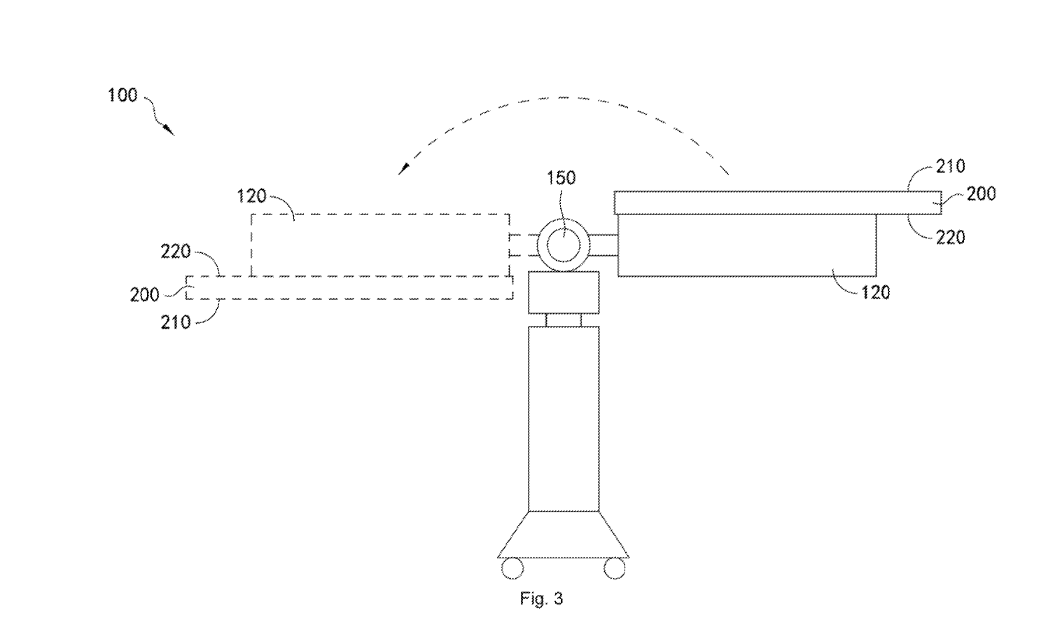

FIG. 3 is a side view of the glass substrate transportation carrier in another operation state according to the present invention. The glass substrate transportation carrier 100 is used to transport a glass substrate 200. The overturning mechanism 150 can overturn the glass substrate 200, and thereby the glass substrate 200 is turned over from the first surface 210 facing upwards to the second surface 220 facing upwards.

As can be known from the embodiments of FIG. 1 to FIG. 3, when the glass substrate 200 is transported for conducting a test, the glass substrate transportation carrier 100 moves to a predetermined position via the moving mechanism 140. Then, the elevating mechanism 130 is adjusted to move the glass holding stage 120 to a proper height. Thereafter, the telescopic mechanism 170 is operated to shift the glass holding stage 120 to the glass substrate cartridge. Afterwards, the elevating mechanism 130 is operated once again to make the glass holding stage 120 contact the glass substrate 200, and the air suction ports 124 are automatically actuated for fixing the glass substrate 200 on the glass holding stage 120 via the suction cups 122 and the air suction ports 124.

Then, the elevating mechanism 130 and the telescopic mechanism 170 are operated once again to take off the glass holding stage 120 from the glass substrate cartridge. The moving mechanism 140 moves the glass substrate transportation carrier 100 to a position beside the test machine, and optionally, the operation rotating mechanism 160 and/or the overturning mechanism 150 are operated to adjust the glass substrate 200 to a desired direction or angle for inspection convenience. Thereafter, the sucking state of the air suction ports 124 is disabled, and the glass substrate 200 is placed against a rib of the test machine, and thus the glass substrate 200 and the glass holding stage 120 are separated and then inspection can be performed briefly.

The aforementioned steps may be repeated for multiple times to finish several inspection procedures, or after the inspection is finished, the aforementioned steps can be carried out in a reverse sequence for sending the glass substrate 200 back to the glass substrate cartridge for storage and transportation.

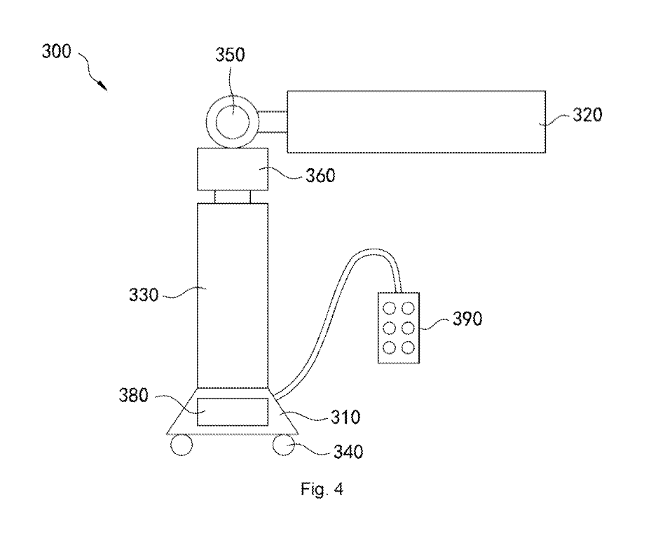

FIG. 4 is a schematic view of a glass substrate transportation carrier according to a second embodiment of the present invention. The glass substrate transportation carrier 300 includes a base 310; a glass holding stage 320; an elevating mechanism 330 disposed between the base 310 and the glass holding stage 320; a moving mechanism 340 disposed on the base 310; an overturning mechanism 350 disposed between the glass holding stage 320 and the elevating mechanism 330; a rotating mechanism 360 disposed between the overturning mechanism 350 and the elevating mechanism 330; a telescopic mechanism 370 connecting the overturning mechanism 350 and the glass holding stage 320; a solar cell 380 disposed on the base 310; and a control panel 390.

The solar cell 380 may be disposed on the base 310 to convert the light in the plant into electrical energy for storage, and the power stored in the solar cell 380 may drive the glass substrate transportation carrier 300. The control panel 390 includes an operational interface and a micro-controller, and the micro-controller is connected respectively to the operational interface, the elevating mechanism 330, the moving mechanism 340, the overturning mechanism 350, the rotating mechanism 360, the telescopic mechanism 370 and the solar cell 380, so that a user can operate the glass substrate transportation carrier 300 to transport a glass substrate through the operational interface on the control panel 390. Alternatively, a control program built in the micro-controller can be used to allow the glass substrate transportation carrier 300 to automatically transport the glass substrate along a preset path.

As can be known from the aforementioned embodiments of the present invention, the application of the present invention has the following advantages. The present invention provides a glass substrate transportation carrier, which can reduce the breakage of glass substrates during transportation and improve to the inspection efficiency of the glass substrates.

Although the present invention has been described in considerable detail with reference to certain embodiments thereof, other embodiments are possible. Various alternations and modifications can be made to these certain embodiments by those skilled in the art without departing from the spirit and scope of the present invention. Such alternations and modifications are intended to fall within the scope of the appended claims.

What is claimed is:

1. A glass substrate transportation carrier, comprising:
a base;
a glass holding stage for adsorbing a glass substrate;
an elevating mechanism disposed between the base and the glass holding stage;
an overturning mechanism, disposed between the elevating mechanism and the glass holding stage;
a rotating mechanism disposed between the overturning mechanism and the elevating mechanism; and
a telescopic mechanism disposed between the overturning mechanism and the glass holding stage.

2. The glass substrate transportation carrier of claim 1, further comprising:
a moving mechanism disposed on the base.

3. The glass substrate transportation carrier of claim 1, wherein the glass holding stage comprises a plurality of suction cups and a plurality of air suction ports.

4. The glass substrate transportation carrier of claim 1, wherein the elevating mechanism is an air pressure cylinder, an oil pressure cylinder or a screw rod.

5. The glass substrate transportation carrier of claim 1, wherein the telescopic mechanism comprises:
a rail and a sliding member, wherein the rail extends from the overturning mechanism, and the sliding member is disposed on the rail and slides relative to the rail, and the sliding member and the glass holding stage are connected.

6. The glass substrate transportation carrier of claim 1, further comprising:
a solar cell disposed on the base.

7. The glass substrate transportation carrier of claim 1, further comprising:
a control panel for controlling the glass substrate transportation carrier.
